(19) United States
(12) Patent Application Publication
(10) Pub. No.: US 2026/0126360 A1
(43) Pub. Date: May 7, 2026

(54) SEMICONDUCTOR PACKAGE WORKPRESS MODULE HAVING MULTIPLE PRESSING BLOCKS AND SEMICONDUCTOR PACKAGE TESTING APPARATUS

(71) Applicant: CHROMA ATE INC., Taoyuan City (TW)

(72) Inventors: Meng-Kung Lu, Taoyuan City (TW); Chien-Ming Chen, Taoyuan City (TW)

(73) Assignee: CHROMA ATE INC., Taoyuan City (TW)

(21) Appl. No.: 19/246,871

(22) Filed: Jun. 24, 2025

(30) Foreign Application Priority Data
Nov. 6, 2024 (TW) 113142618

(51) Int. Cl. G01N 3/12; G01N 3/02

(52) U.S. Cl. CPC G01N 3/12; G01N 3/02

(57) ABSTRACT

A semiconductor package workpress module having pressing blocks is provided. The semiconductor package workpress module includes a base and a plurality of movable pressing blocks. The base includes an internal chamber and a plurality of open slots. The open slots are in communication with the internal chamber. The movable pressing blocks are accommodated in the open slots of the base. The movable pressing blocks correspond to different regions on the semiconductor package. In response to that the internal chamber is filled with high-pressure fluid, the movable pressing blocks generate a pressing force toward the regions. A semiconductor package testing apparatus is also provided. A controller is configured to control the fluid supply unit to supply the high-pressure fluid for the internal chamber of the base and configured to perform a test on the semiconductor package through a testing stage.

### CROSS-REFERENCE TO RELATED APPLICATION

This non-provisional application claims priority under 35 U.S.C. § 119(a) to Patent Application No. 113142618 filed in Taiwan, R.O.C. on Nov. 6, 2024, the entire contents of which are hereby incorporated by reference.

### BACKGROUND

### Technical Field

The instant disclosure relates to a semiconductor package testing apparatus and in particular to a semiconductor package workpress module having pressing blocks.

### Related Art

In a semiconductor packaging element testing technology known to the inventor, a single workpress is usually adopted to perform testing. The main purpose of the workpress is to apply a pressing force to the semiconductor package to ensure proper electrical connection between a packaging element and a test probe, thereby maintaining validity of the test. However, as the semiconductor packaging technology rapidly develops, the single-workpress manner has become insufficient to meet the demands of next-generation technologies, in particular in the 3D packaging application field. Such advanced packaging can arrange a plurality of dies (such as a CPU, a GPU, a SOC, a logic die, or a high bandwidth memory) on an upper surface of the package, resulting in more complex packaging structure. Moreover, due to different conditions regarding areas, thicknesses and required forces for these dies, testing accuracy and apparatus are required to meet higher standards.

Therefore, a testing apparatus known to the inventor that relies on a single workpress has become unsuitable for such advanced semiconductor packaging. Since the single workpress known to the inventor may not be able to contact each of the dies sufficiently and may struggle to apply appropriate pressing forces to all of the dies, an issue of inconsistent distribution of pressure may occur during a pressing test, and issues of regional overpressure or underpressure can occur easily, resulting in regional poor contact, or warpage or deformation can even occur on the entire semiconductor package. Ultimately, stability of packaging and accuracy of test results may be influenced.

### SUMMARY

In view of the above, an embodiment of the instant disclosure provides a semiconductor package workpress module having pressing blocks and a semiconductor package testing apparatus. Pressing forces can be applied to a plurality of regions on the semiconductor package at the same time, to ensure full electrical contact between the dies and probes of a testing stage and prevent deformation from occurring to the dies.

In some embodiments, a semiconductor package workpress module having pressing blocks is disclosed. The semiconductor package workpress module having pressing blocks includes a base and a plurality of movable pressing blocks. The base includes at least one internal chamber and a plurality of open slots. The open slots are in communication with the at least one internal chamber. The movable pressing blocks are respectively accommodated in the open slots of the base. The movable pressing blocks respectively correspond to different regions on the semiconductor package. In response to that the at least one internal chamber is filled with at least one high-pressure fluid, the movable pressing blocks respectively generate pressing forces toward the regions. The regions may include certain regions on a substrate of the semiconductor package, dies on the substrate, and certain regions on the dies.

In some embodiments, the semiconductor package testing apparatus includes the aforementioned semiconductor package workpress module having pressing blocks, a fluid supply unit, a testing stage, and a controller. The fluid supply unit is in communication with the at least one internal chamber. The testing stage corresponds to the semiconductor package workpress module having pressing blocks and is configured to accommodate the semiconductor package. The controller is electrically connected to the fluid supply unit and the testing stage. The controller is configured to control the fluid supply unit to supply the high-pressure fluid for the at least one internal chamber of the semiconductor package workpress module having pressing blocks and is configured to perform testing on the semiconductor package through the testing stage.

In some embodiments, the semiconductor package workpress module having pressing blocks is configured to test a semiconductor package. The surface of the semiconductor package includes a plurality of regions. The semiconductor package workpress module having pressing blocks includes a base, a plurality of movable pressing blocks, and at least one elastic member. The base includes at least one internal chamber and a plurality of open slots. The open slots are in communication with the at least one internal chamber. The movable pressing blocks are respectively accommodated in the open slots of the base. The at least one elastic member is accommodated in the at least one internal chamber and corresponds to the open slots. The movable pressing blocks respectively correspond to the regions on the semiconductor packages. In response to that at least one of the movable pressing blocks receives an external force and abuts at least one elastic member, the at least one elastic member drives at least one of the movable pressing blocks to generate the pressing force toward at least one of the regions.

As described above, the semiconductor package workpress module having pressing blocks and the semiconductor package testing apparatus proposed by one or some embodiments of the instant disclosure can apply appropriate pressing forces to different dies or regions on the semiconductor package in accordance with actual demands. Such pressing forces are provided by a high-pressure fluid system, so that the pressing force applied to each of the regions or the dies is identical or different in accordance with a special condition. For example, when testing a semiconductor package which adopts an advanced packaging technology, predetermined pressing force values may be provided for various dies or regions of the semiconductor package. This can not only ensure full electrical contact between the semiconductor package and testing stage probes but also prevent the semiconductor package from warpage or deformation due to inconsistent force distribution. In addition, according to one or some embodiments of the instant disclosure, in the process of controlling the pressing process through the fluid pressures, the use of another actuator or pressure generator is not necessarily needed, and a volume of the workpress module is thereby effectively reduced, allowing the proposed module to be more suitable for a compact design.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a perspective view of a semiconductor package workpress module having pressing blocks of an embodiment;

FIG. 2 illustrates a perspective view of a semiconductor package of an embodiment.

FIG. 3 illustrates an exploded view of a semiconductor package workpress module having pressing blocks of an embodiment, wherein the upper housing is presented from an oblique upward view, the lower housing is presented from an oblique downward view, and the movable pressing blocks is not presented in this drawing;

FIG. 4 illustrates a cross-sectional view of a semiconductor package workpress module having pressing blocks of an embodiment;

FIG. 5 illustrates a schematic diagram of a semiconductor package of an embodiment testing apparatus;

FIG. 6 illustrates a cross-sectional view of a semiconductor package workpress module having pressing blocks of an embodiment;

FIG. 7 illustrates a cross-sectional view of a semiconductor package workpress module having pressing blocks of an embodiment;

FIG. 8A illustrates a cross-sectional view of a semiconductor package workpress module having pressing blocks of an embodiment; and

FIG. 8B illustrates a cross-sectional view of a semiconductor package workpress module having pressing blocks of an embodiment.

### DETAILED DESCRIPTION

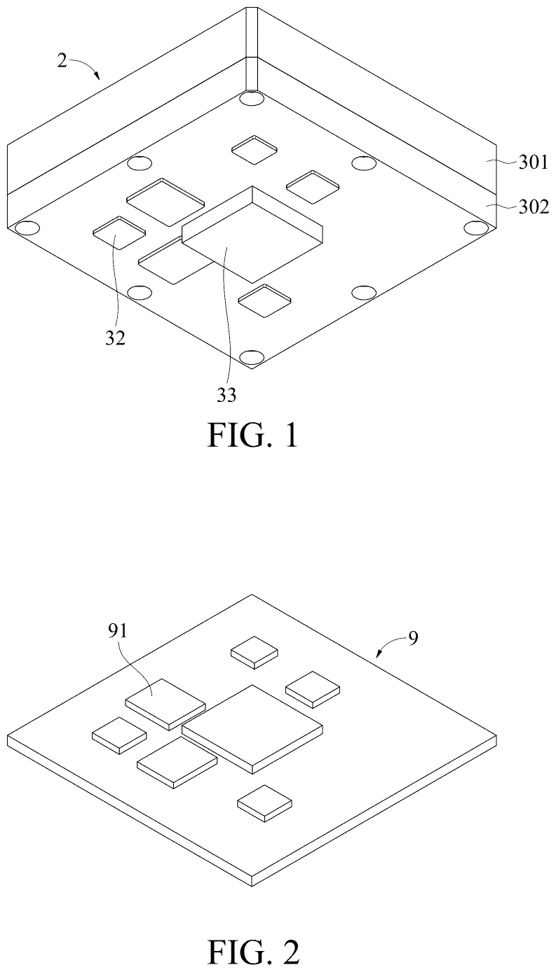

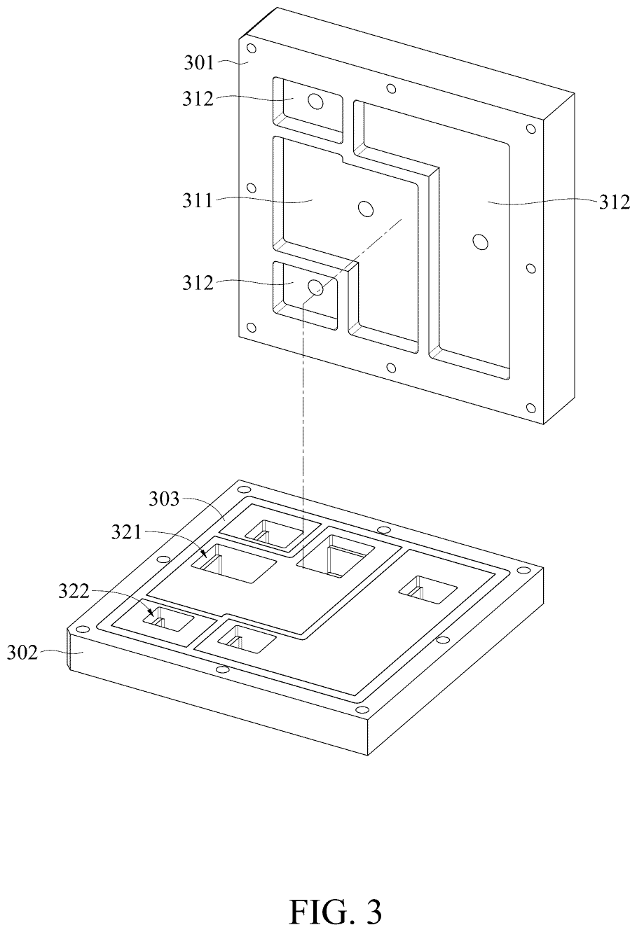

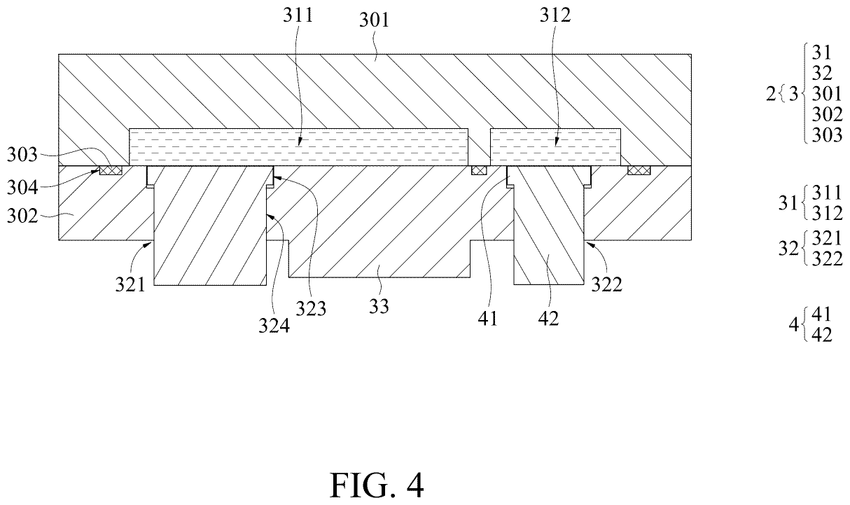

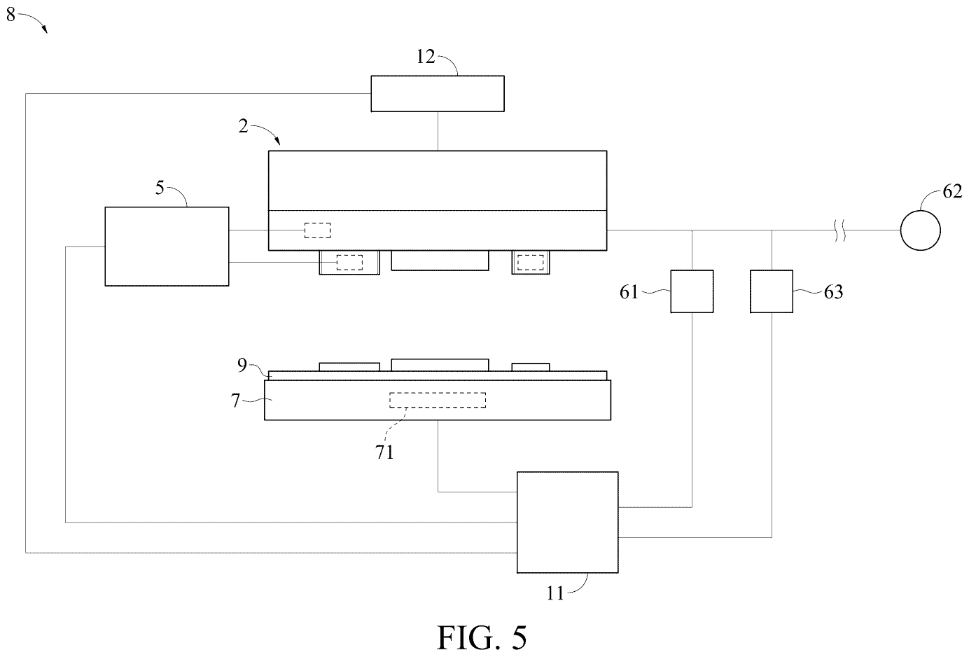

Please refer to FIG. 1 to FIG. 4. FIG. 1 illustrates a perspective view of a semiconductor package workpress module 2 having pressing blocks of an embodiment. FIG. 2 illustrates a perspective view of a semiconductor package 9 of an embodiment. FIG. 3 illustrates an exploded view of a semiconductor package workpress module 2 having pressing blocks of an embodiment, wherein an upper housing 301 (explained later) is presented from an oblique upward view, a lower housing 302 (explained later) is presented from an oblique downward view, and a movable pressing blocks 4 (explained later) is not presented in this drawing. FIG. 4 illustrates a cross-sectional view of a semiconductor package workpress module 2 having pressing blocks of an embodiment. In some embodiments, a plurality of dies 91 is on the semiconductor package 9. The semiconductor package workpress module 2 having pressing blocks includes a base 3 and a plurality of movable pressing blocks 4. The base 3 includes at least one internal chamber 31 and a plurality of open slots 32. The open slots 32 are in communication with the at least one internal chamber 31. The movable pressing blocks 4 are respectively accommodated in the open slots 32 of the base 3. The movable pressing blocks 4 respectively correspond to the dies 91 on the semiconductor package 9.

In another embodiment, the movable pressing blocks 4 may also respectively correspond to other regions on the semiconductor package 9. The regions may be any certain regions on the semiconductor packaging element, including but not limited to an empty region on the substrate not arranged with a transistor. In addition, in some embodiments, when applying a pressing force to the dies 91, the application may be to the entire region or certain regions of the dies 91, such as certain regions on large dies with higher thermal design power (TDP). In response to that the at least one internal chamber 31 is filled with a high-pressure fluid, the movable pressing blocks 4 respectively generate the pressing forces toward the dies 91 or another region.

In some embodiments, the semiconductor package 9 adopts an advanced packaging technology. The upper surface of the semiconductor package 9 is arranged with a plurality of dies 91, such as but not limited to a CPU, a GPU, an HBM (high bandwidth memory), an SOC (system on chip), and a logic die. In some embodiments, the semiconductor package 9 may also be a heterogeneous integration semiconductor packaging structure or a silicon photonics (SiPh) package.

In some embodiments, the base 3 further includes a fixed pressing block 33. The fixed pressing block 33 corresponds to one of the dies 91 on the semiconductor package 9 (usually to the die 91 at the central region of the semiconductor package 9 occupying the largest area), such as a CPU or a GPU. Alternatively, in some embodiments, the fixed pressing block 33 may also correspond to another region on the semiconductor package 9. In some embodiments, such region may be a region occupying a larger substrate area. The fixed pressing block 33 and the base 3 are formed as a single unit, and the fixed pressing block 33 usually protrudes from a lower surface of the base 3. When the base 3 as a whole (or the semiconductor package workpress module 2 having pressing blocks as a whole) moves (such as through a displacement generation device 12, illustrated later), the fixed pressing block 33 then moves along with the movement of the base 3, so that the fixed pressing block 33 generates a pressing force toward the die 91 or another region. In some embodiments, the fixed pressing block 33 may also correspond to several dies 91. For example, the fixed pressing block 33 may directly press against several dies 91 with identical or similar heights.

In the embodiment shown in FIG. 1, FIG. 3 and FIG. 4, the semiconductor package workpress module 2 having pressing blocks has a fixed pressing block 33 and six movable pressing blocks 4. The movable pressing blocks 4 respectively correspond to the dies 91 or other regions on the semiconductor package 9 shown in FIG. 2, but the instant disclosure is not limited thereto. In different embodiments, for the semiconductor package 9 of different forms, the number of the fixed pressing block 33 and the movable pressing blocks 4 and are not limited to one and six respectively, and a relative location relationship, shapes, and sizes of the fixed pressing block 33 and the movable pressing blocks 4 may also be adjusted accordingly. In some embodiments, the semiconductor package 9 may have more than one fixed pressing block 33. In some embodiments, a die 91 may correspond to several movable pressing blocks 4. In some embodiments, one movable pressing block 4 may correspond to several dies 91.

In the embodiment shown in FIG. 3, the at least one internal chamber 31 includes one first chamber 311 and three second chambers 312, the open slots 32 includes a plurality of first open slots 321 and a plurality of second open slots 322. In this embodiment, the first open slots 321 correspond to and are in communication with the first chamber 311, and the second open slots 322 correspond to and are in communication with the second chambers 312. In response to that the first chamber 311 and the second chambers 312 are respectively filled with a first high-pressure fluid and a second high-pressure fluid, the movable pressing blocks 4 generate a plurality of pressing forces toward the dies 91 or other regions. In this embodiment, by respectively filling the first high-pressure fluid and the second high-pressure fluid of different pressures into the first chamber 311 and the second chambers 312, the movable pressing blocks 4 generate the pressing forces with different magnitudes toward the dies 91 or other regions. However, a type and the number of the internal chambers 31 are both not limited thereto. In addition, in different embodiments, the high-pressure fluids filled in the internal chambers 31 may provide identical or different pressures.

In some embodiments, the first high-pressure fluid and the second high-pressure fluid may each be a gas or a liquid. The gas may be air or liquid nitrogen. In addition, when a liquid serves as the high-pressure fluid, a risk of short circuit due to leakage should be considered, and therefore non-conductive liquids such as an electronic fluorinated liquid, a silicone oil, an electronic engineering fluid, and a deionized water may be adopted. Furthermore, based on the formula that the pressing force (F) is equal to the product of a fluid pressure (P) and a force-bearing area (A), in some embodiments, the fluid pressures of the first high-pressure fluid and the second high-pressure fluid may be identical. Thus, because force-bearing cross-sectional areas of the movable pressing blocks 4 are different, the pressing forces with different magnitudes may be generated. On the other hand, the first high-pressure fluid and the second high-pressure fluid of different pressures may also be correspondingly set in accordance with the different force-bearing cross-sectional areas of the movable pressing blocks 4, so that the movable pressing blocks 4 generate the pressing forces with identical magnitudes toward the dies 91 or other regions.

In some embodiments, temperatures of the first high-pressure fluid and the second high-pressure fluid may be different. In this embodiment, the movable pressing blocks 4 is made of a material with good thermal conductivity, such as copper alloy or aluminum alloy. Therefore, through the high-pressure fluid at different temperatures, the movable pressing blocks 4 may respectively generate different temperature control performances toward the dies 91 or other regions. To explain further, the high-pressure fluid with lower temperature may flow through the movable pressing blocks 4 and the internal chambers 31 corresponding to the dies 91 having larger thermal design powers, so as to keep all of the dies 91 or regions at a consistent operating temperature.

Please refer to FIG. 3 and FIG. 4. In some embodiments, the base 3 includes the upper housing 301, the lower housing 302, and a sealing member 303. In this embodiment, the first chamber 311 and the second chambers 312 are at the upper housing 301, the open slots 32 are at the lower housing 302, the lower housing 302 is provided with a annular slot 304, the annular slot 304 surrounds all of the internal chambers 31, and the sealing member 303 is accommodated in the annular slot 304. In one embodiment, the sealing member 303 is made of thermoplastic polyurethane (TPU), silicone, or rubber. The sealing member 303 can prevent the fluid in the internal chambers 31 from escaping to an exterior of the base 3 and can also prevent the fluid from escaping between the different internal chambers 31. In some embodiments, the sealing member 303 may also be directly implemented using a sealing gasket, so that the open slots 32 can be omitted.

In some embodiments, each of the open slots 32 includes a radial extension portion 323 and an axial penetration portion 324, and each of the movable pressing blocks 4 includes a radial flange 41 and an axial body 42. The axial body 42 penetrates through the axial penetration portion 324. The radial extension portion 323 is configured to stop the radial flange 41. The radial flange 41 extends outward radially relative to a main axis of the axial body 42. For example, the radial flange 41 may extend in one or several radial directions relative to the main axis of the axial body 42 to form a polygon, a circle, or an irregular shape. A shape of the radial extension portion 323 may match a shape of the radial flange 41 but may also not match the shape of the radial flange 41, as long as the radial flange 41 can be appropriately stopped by the radial extension portion 323. In addition, a surface of the radial extension portion 323 opposite to the axial body 42 may be a planar surface or a non-planar surface.

In some embodiments, an axial length of the axial body 42 of each of the movable pressing blocks 4 may be designed in accordance with a thickness and configuration manner of a corresponding die 91. For example, in the case where the thicknesses of the dies 91 are largely different, lengths of the axial bodies 42 of the movable pressing blocks 4 may be adjusted to be different in accordance with the thicknesses of the corresponding dies 91. This may ensure that each of the movable pressing blocks 4 is able to apply full pressing forces toward the dies 91; however, the instant disclosure is not limited thereto. In another embodiment, axial lengths of the axial bodies 42 of the movable pressing blocks 4 may be identical, because the movable pressing blocks 4 themselves can already provide tolerances along the height direction.

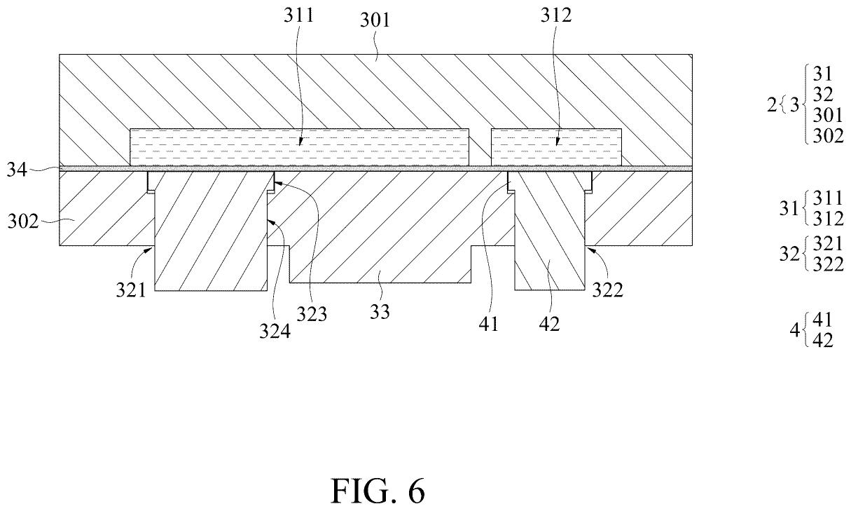

Please also refer to FIG. 5. FIG. 5 illustrates a schematic diagram of an embodiment of a semiconductor package testing apparatus 8. In some embodiments, the semiconductor package testing apparatus 8 includes the aforementioned semiconductor package workpress module 2 having pressing blocks, a fluid supply unit 6, a testing stage 7, and a controller 11. The fluid supply unit 6 is in communication with the at least one internal chamber 31. The testing stage 7 corresponds to the semiconductor package workpress module 2 having pressing blocks and is configured to accommodate the semiconductor package 9. The controller 11 is electrically connected to the fluid supply unit 6 and the testing stage 7. The controller 11 is configured to control the fluid supply unit 6 to supply the high-pressure fluid for the at least one internal chamber 31 of the semiconductor package workpress module 2 having pressing blocks, and the controller 11 is configured to perform testing on the semiconductor package 9 through the testing stage 7.

In some embodiments, the semiconductor package testing apparatus 8 further includes the displacement generation device 12. In this embodiment, the displacement generation device 12 is electrically connected to the controller 11, the base 3 of the semiconductor package workpress module 2 having pressing blocks is connected to the displacement generation device 12, and the controller 11 is configured to control the displacement generation device 12 so that the semiconductor package workpress module 2 having pressing blocks moves toward or moves away from the testing stage 7. In some embodiments, the displacement generation device 12 is a linear actuator, such as a lifting device, which may be but not limited to a pneumatic cylinder, a hydraulic cylinder, a combination of a motor and a transmission mechanism, a robotic arm, or another equivalent device capable of generating lifting displacement and pressing force.

In some embodiments, the controller 11 may be but not limited to a central processing unit (CPU), a microcontroller unit (MCU), a digital signal processor (DSP), a programmable logic controller (PLC), an application-specific integrated circuit (ASIC), a programmable logic device (PLD) or another similar device or a combination of such devices. In another embodiment, the controller 11 may also implement various operating functions through a hardware circuit. Examples of such hardware circuit includes but is not limited to a workstation, a laptop, a client terminal, a server, a distributed computing system, a handheld device, or any other calculating system or device. In a most basic configuration, the controller 11 may include at least a processor and a system memory.

In some embodiments, the fluid supply unit 6 includes a valve 61 and a high-pressure fluid source 62. In this embodiment, the high-pressure fluid source 62 is in communication with the at least one internal chamber 31, the valve 61 is disposed between the high-pressure fluid source 62 and the at least one internal chamber 31 and electrically connected to the controller 11, and the controller 11 turns the valve 61 on or off to control whether the high-pressure fluid source 62 supplies the high-pressure fluid for the at least one internal chamber 31. In some embodiments, the valve 61 may be a general-purpose solenoid valve or may also adopt a proportional valve to adjust a flow rate and pressure of the high-pressure fluid provided to the at least one internal chamber 31 directly, but the instant disclosure is not limited thereto.

In some embodiments, the semiconductor package testing apparatus 8 further includes a fluid temperature control unit 63. In this embodiment, the fluid temperature control unit 63 is disposed between the high-pressure fluid source 62 and the at least one internal chamber 31 and electrically connected to the controller 11, and the controller 11 controls the fluid temperature control unit 63 to adjust a temperature of the high-pressure fluid supplied for the at least one internal chamber 31.

In some embodiments, the semiconductor package testing apparatus 8 further includes a workpress module temperature control unit 5. In this embodiment, the workpress module temperature control unit 5 is disposed in at least one of the base 3 and the movable pressing blocks 4 and electrically connected to the controller 11, and the controller 11 controls the workpress module temperature control unit 5 to adjust the temperature of at least one of the base 3 and the plurality of movable pressing blocks 4.

In some embodiments, the semiconductor package testing apparatus 8 further includes a testing stage temperature control unit 71. In this embodiment, the testing stage temperature control unit 71 is electrically connected to the controller 11, and the controller 11 controls the testing stage temperature control unit 71 to adjust the temperature of the testing stage 7. Thereby, with the combination of the fluid temperature control unit 63, the workpress module temperature control unit 5, and the testing stage temperature control unit 71, a complete environmental temperature control for the semiconductor package 9 can be established, and therefore the semiconductor package 9 can be fully immersed in a high-temperature or low-temperature testing environment to increase test efficiency and test accuracy.

In some embodiments, the fluid temperature control unit 63, the workpress module temperature control unit 5, and the testing stage temperature control unit 71 may each be at least one of a heating unit and a cooling unit. The heating unit may be a heater composed of an electric heating element, a resistive heating element, or another equivalent element capable of controlled heating. In some embodiments, the heating unit may also be composed of pipes or chambers through which a high-temperature fluid flows. The cooling unit may be composed of a temperature-controlled fluid channel. In some embodiments, the cooling unit may be a cooling distribution unit (CDU) or a chiller. In some other embodiments, the cooling unit may be a thermo-electric module or a vapor-compression refrigeration system (VCRS). In some embodiments, the cooling unit may also be a condenser, such as a winding channel through which a refrigerant flows, where the refrigerant may be liquid nitrogen, ethylene glycol, halocarbon, ammonia gas, sulfur dioxide, methane, or other low-temperature fluids.

In some embodiments, the fluid temperature control unit 63, the workpress module temperature control unit 5, and the testing stage temperature control unit 71 may respectively generate identical or different temperature control performances for the fixed pressing block 33, the movable pressing blocks 4, or the testing stage 7 in accordance with the thermal design power (TDP) of each of the dies 91 or the entirety of the semiconductor package 9.

In some embodiments, a force sensing unit (not shown in the drawings) and a temperature sensing unit (not shown in the drawings) may be respectively provided on the fixed pressing block 33 and the movable pressing blocks 4. The force sensing unit and the temperature sensing unit are electrically connected to the controller 11, and the force sensing units may be controlled to respectively measure the pressing forces respectively applied to the dies 91 or other regions on the semiconductor package 9 by the fixed pressing block 33 and the movable pressing blocks 4. Therefore, the dies 91 or other regions can be ensured to be applied with sufficient pressing forces. The force sensing units may be but not limited to load cells, capacitive pressure sensors, piezoresistive pressure sensors, or pressure sensors of any other type.

In addition, in some embodiments, each of the fixed pressing block 33 and the movable pressing blocks 4 is provided with a temperature sensing unit (not shown in the drawings), and the temperature sensing units may be controlled to respectively measure the temperatures of the dies 91 on the semiconductor package 9. Accordingly, the fluid temperature control unit 63, the workpress module temperature control unit 5, and the temperature sensing units may be operated collectively to adjust the temperature of each of the dies 91 and therefore ensure that each of the dies 91 is maintained at a preset temperature value.

In some embodiments, the temperature value sensed by the temperature sensing unit will be sent to the controller 11. When a sensed temperature value is abnormal, the controller 11 will control at least one of the fluid temperature control unit 63, the workpress module temperature control unit 5, and the testing stage temperature control unit 71 to further heat up or cool down the dies 91 on the semiconductor package 9. If the abnormal temperature persists, the controller 11 will alert the user and stop the testing process.

The following description will introduce some different embodiments of the semiconductor package workpress module 2 having pressing blocks. These embodiments may be combined with at least a portion of the aforementioned semiconductor package testing apparatus 8.

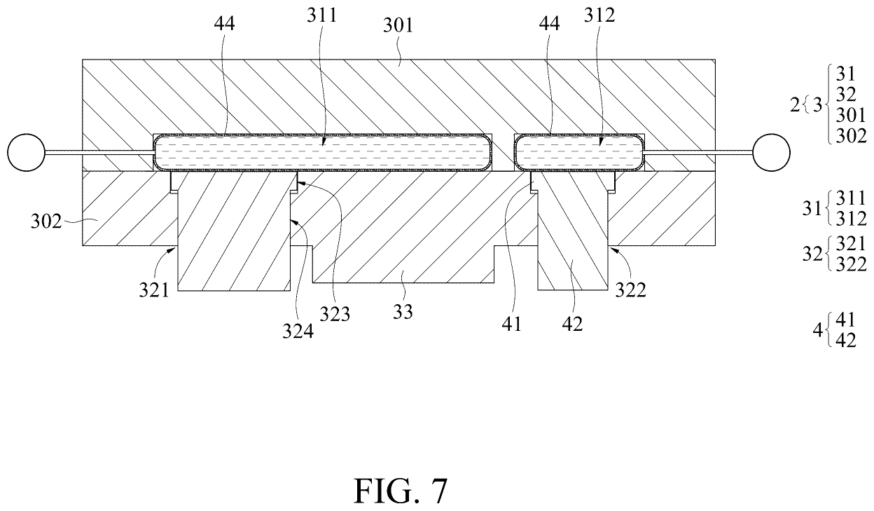

Please refer to FIG. 6. FIG. 6 illustrates a cross-sectional view of the semiconductor package workpress module 2 having pressing blocks of an embodiment. In some embodiments, the base 3 includes an upper housing 301, a lower housing 302, and a diaphragm 34, the internal chamber 31 is at the upper housing 301, the open slots 32 are at the lower housing 302, and the diaphragm 34 is between the upper housing 301 and the lower housing 302. This embodiment may be understood as a variation of the embodiment of FIG. 4. In this embodiment, the pressures of the first high-pressure fluid and the second high-pressure fluid will be transmitted to the movable pressing blocks 4 through the diaphragm 34, so that the movable pressing blocks 4 generate a plurality of pressing forces toward the dies 91 or other regions. At the same time, the diaphragm 34 can prevent the fluid in the internal chamber 31 from escaping to the exterior of the base 3 and can also prevent the fluid from escaping between different internal chambers 31. In addition, since the risk of fluid leakage is avoided, fluid pressure may be increased, and the pressing force may be increased thereby. In some embodiments, the diaphragm 34 is made of silicone, rubber, or an elastic polymer film.

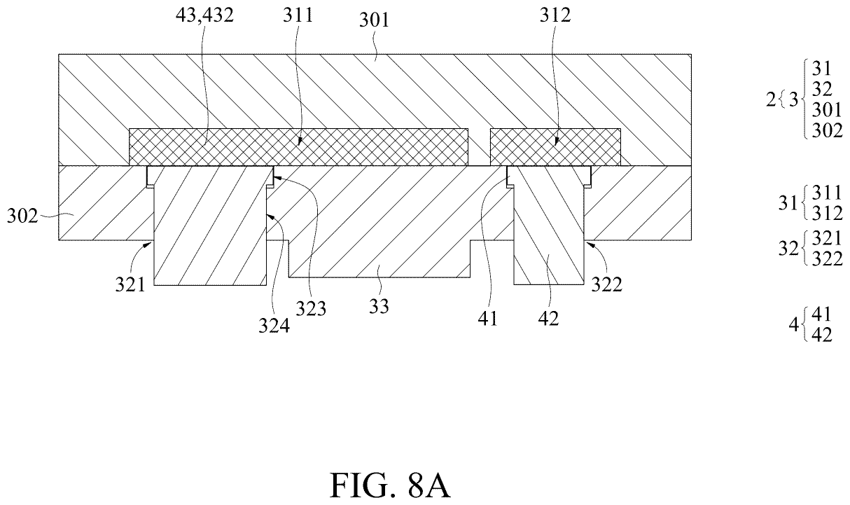

Please refer to FIG. 7. FIG. 7 illustrates a cross-sectional view of the semiconductor package workpress module 2 having pressing blocks of an embodiment. In some embodiments, the semiconductor package workpress module 2 having pressing blocks further includes at least one sack 44, and the at least one sack 44 is accommodated in the at least one internal chamber 31. In this embodiment, in response to that the at least one sack 44 in the at least one internal chamber 31 is filled with a high-pressure fluid, at least one movable pressing block 4 corresponding to the at least one sack 44 being filled with the high-pressure fluid generates at least one pressing force toward the semiconductor package 9. This embodiment may be understood as a variation of the embodiment of FIG. 4.

In this embodiment, the pressures of the first high-pressure fluid and the second high-pressure fluid will be transmitted to the movable pressing blocks 4 through the at least one sack 44, so that the at least one movable pressing block 4 generates at least one pressing forces toward the semiconductor package 9. At the same time, the at least one sack 44 can prevent the fluid in the at least one internal chamber 31 from escaping to an exterior of the base 3 and can also prevent the fluid from escaping between different internal chambers 31. In addition, since the sack 44 may be formed as an enclosed chamber, the sack 44 may be filled with a high-pressure fluid with higher pressure, allowing the at least one movable pressing block 4 to provide a greater pressing force. In other words, in this embodiment, by adjusting the pressure of the high-pressure fluid filled into the at least one sack 44, the output force of the at least one movable pressing block 4 may be actively adjusted. In some embodiments, a material of the at least one sack 44 is at least one selected from the group consisting of nylon, polyurethane, polyvinyl chloride, thermoplastic polyurethane, rubber, polyethylene, and silicone.

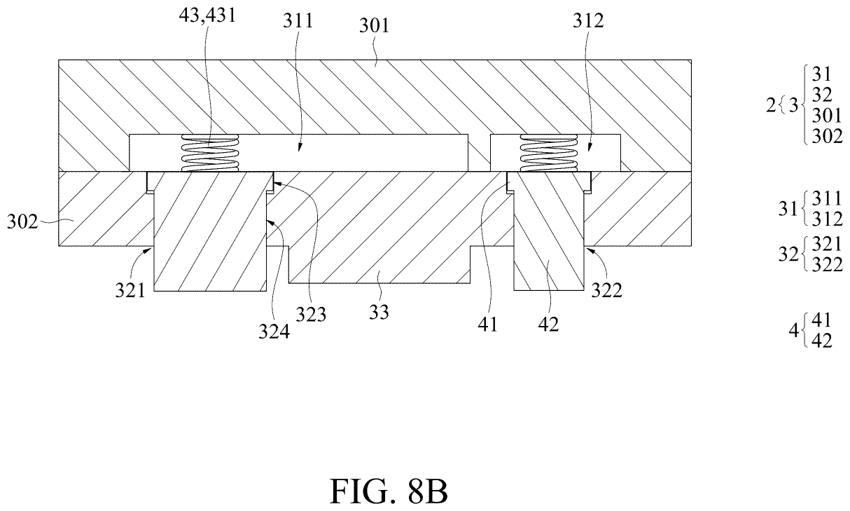

Please refer to FIG. 8A and FIG. 8B. FIG. 8A illustrates a cross-sectional view of the semiconductor package workpress module 2 having pressing blocks of an embodiment. FIG. 8B illustrates a cross-sectional view of the semiconductor package workpress module 2 having pressing blocks of an embodiment. In some embodiments, the semiconductor package workpress module 2 having pressing blocks includes at least one elastic member 43. The at least one elastic member 43 is accommodated in the at least one internal chamber 31 and corresponds to the open slots 32. In some embodiments, in response to that at least one of the movable pressing blocks 4 receives an external force and abuts against the at least one elastic member 43, the at least one elastic member 43 drives the at least one movable pressing block 4 to generate at least one pressing force toward semiconductor package 9. In other words, in some embodiments, the semiconductor package workpress module 2 having pressing blocks generates at least one pressing force passively in response to that an external force pushes at least one of the movable pressing blocks 4.

In some embodiments, the at least one internal chamber 31 includes a plurality of internal chambers 31, the at least one elastic member 43 includes a plurality of elastic members 43, and the elastic members 43 are respectively accommodated in the internal chambers 31 and respectively correspond to the open slots 32.

Specifically, in some embodiments, the elastic members 43 may be springs 431 (as shown in FIG. 8B) or other solid elastic members (as shown in FIG. 8A), the solid elastic members may be rubbers 432, shape-memory alloys, or other elastic members capable of providing elastic forces upon compression. In these embodiments, in response to that at least one of the movable pressing blocks 4 is applied with an external force and abuts against at least one of the elastic members 43, the at least one elastic member 43 is deformed and exerts a restoring force, and therefore the at least one movable pressing block 4 is driven to generate at least one pressing force toward the semiconductor package 9.

In another embodiment, the elastic members 43 may include the sacks 44 (as shown in FIG. 7), and the sacks 44 are filled with the high-pressure fluids. In some embodiments, the combination of the diaphragm 34 and the high-pressure fluid shown in FIG. 6 may also serve as the elastic members 43, and such combination can be applied for one or several internal chambers 31. For example, when the movable pressing blocks 4 are applied with an external force and abut against the sacks 44, the sacks 44 are deformed and exert restoring forces, and therefore the movable pressing blocks 4 are driven to generate a pressing force toward the dies 91 or another region.

As above, the semiconductor package workpress module 2 having pressing blocks and the semiconductor package testing apparatus 8 comprising the semiconductor package workpress module 2 having pressing blocks proposed by one or some embodiments of the instant disclosure can apply the pressing forces for each of the dies 91 or the regions on the semiconductor package 9 based on actual demands. Such pressing forces may be set to be identical or different through the high-pressure fluids, and therefore the dies 91 or the regions can be pressed respectively. For example, some embodiments of the instant disclosure are suitable for different dies 91 (such as CPU, GPU, SoC, and HBM) or regions on the semiconductor package 9 adopting advanced packaging and provide each of the dies 91 or the regions a required predetermined pressing force. Therefore, not only is full electrical contact between the semiconductor package 9 and probes of the testing stage 7 is ensured, warpage or deformation of the semiconductor package 9 due to inconsistent force distribution is also prevented. Furthermore, temperature control may be performed on the semiconductor package 9, and individual temperature control may even be performed on individual dies 91 on the semiconductor package 9.

What is claimed is:

1. A semiconductor package workpress module having pressing blocks, wherein the semiconductor package workpress module having pressing blocks is adapted to test a semiconductor package, a surface of the semiconductor package includes a plurality of regions, and the semiconductor package workpress module having pressing blocks includes:
a base having at least one internal chamber and a plurality of open slots, wherein the open slots are in communication with the at least one internal chamber; and
a plurality of movable pressing blocks respectively accommodated in the open slots of the base;
wherein the movable pressing blocks respectively correspond to the regions on the semiconductor package; in response to that the at least one internal chamber is filled with at least one high pressure fluid, the movable pressing blocks respectively generate a pressing force toward the regions.

2. The semiconductor package workpress module having pressing blocks according to claim 1, wherein the base further includes a fixed pressing block corresponding to a die among a plurality of dies on the semiconductor package.

3. The semiconductor package workpress module having pressing blocks according to claim 1, wherein the at least one internal chamber includes a first chamber and a second chamber, the open slots include a first open slot and a second open slot, the at least one high pressure fluid includes a first high pressure fluid and a second high pressure fluid; the first open slot is in communication with the first chamber, the second open slot is in communication with the second chamber; and in response to that the first chamber and the second chamber are respectively filled with the first high pressure fluid and the second high pressure fluid, the movable pressing blocks generate a plurality of pressing forces toward the regions.

4. The semiconductor package workpress module having pressing blocks according to claim 3, wherein pressures of the first high pressure fluid and the second high pressure fluid are different.

5. The semiconductor package workpress module having pressing blocks according to claim 3, wherein temperatures of the first high pressure fluid and the second high pressure fluid are different.

6. The semiconductor package workpress module having pressing blocks according to claim 1, wherein the base includes an upper housing, a lower housing, and a sealing member, the at least one internal chamber is at the upper housing, the open slots are at the lower housing; the lower housing is provided with an annular slot surrounding the at least one internal chamber, and the sealing member is accommodated in the annular slot.

7. The semiconductor package workpress module having pressing blocks according to claim 1, wherein the base includes an upper housing, a lower housing, and a diaphragm, the at least one internal chamber is at the upper housing, the open slots are at the lower housing; and the diaphragm is between the upper housing and the lower housing.

8. The semiconductor package workpress module having pressing blocks according to claim 1, further including at least one sack accommodated in the at least one internal chamber; wherein, in response to that the at least one sack in the at least one internal chamber is filled with the at least one high pressure fluid, the movable pressing blocks respectively generate the pressing force toward the regions.

9. The semiconductor package workpress module having pressing blocks according to claim 1, wherein each of the open slots includes a radial extension portion and an axial penetration portion, each of the movable pressing blocks includes a radial flange and an axial body; the axial body penetrates through the axial penetration portion, and the radial extension portion is configured to stop the radial flange.

10. A semiconductor package testing apparatus including:
the semiconductor package workpress module having pressing blocks according to claim 1;
a fluid supply unit in communication with the at least one internal chamber;
a testing stage corresponding to the semiconductor package workpress module having pressing blocks and configured to accommodate a semiconductor package; and
a controller electrically connected to the fluid supply unit and the testing stage;
wherein the controller is configured to control the fluid supply unit to supply the at least one high pressure fluid to the at least one internal chamber of the semiconductor package workpress module having pressing blocks and configured to perform a test on the semiconductor package through the testing stage.

11. The semiconductor package testing apparatus according to claim 10, further including a displacement generation device electrically connected to the controller; wherein the base of the semiconductor package workpress module having pressing blocks is connected to the displacement generation device; and the controller is configured to control the displacement generation device so that the semiconductor package workpress module having pressing blocks moves toward or moves away from the testing stage.

12. The semiconductor package testing apparatus according to claim 10, wherein the fluid supply unit includes a valve and a high pressure fluid source; the high pressure fluid source is in communication with the at least one internal chamber, the valve is disposed between the high pressure fluid source and the at least one internal chamber and electrically connected to the controller; and the controller turns the valve on or off to control whether the high pressure fluid source supplies the at least one high pressure fluid to the at least one internal chamber.

13. The semiconductor package testing apparatus according to claim 10, further including a fluid temperature control unit; wherein the fluid temperature control unit is disposed between the high pressure fluid source and the at least one internal chamber and electrically connected to the controller; and the controller controls the fluid temperature control unit to adjust a temperature of the at least one high pressure fluid supplied to the at least one internal chamber.

14. The semiconductor package testing apparatus according to claim 10, further including a workpress module temperature control unit; wherein the workpress module temperature control unit is disposed in the base and in at least one of the movable pressing blocks and electrically connected to the controller; and the controller controls the workpress module temperature control unit to adjust temperatures of the base and the at least one of the movable pressing blocks.

15. The semiconductor package testing apparatus according to claim 10, further including a testing stage temperature control unit; wherein the testing stage temperature control unit is electrically connected to the controller; and the controller controls the testing stage temperature control unit to adjust a temperature of the testing stage.

16. A semiconductor package workpress module having pressing blocks, where in the semiconductor package workpress module is configured to test a semiconductor package, a surface of the semiconductor package includes a plurality of regions, and the semiconductor package workpress module having pressing blocks includes: a base having at least one internal chamber and a plurality of open slots, wherein the open slots are in communication with the at least one internal chamber;
a plurality of movable pressing blocks respectively accommodated in the open slots of the base; and
at least one elastic member accommodated in the at least one internal chamber and corresponding to the open slots;
wherein the movable pressing blocks respectively correspond to the regions on the semiconductor package; and in response to that at least one of the movable pressing blocks receives an external force and abuts the at least one elastic member, the at least one elastic member drives at least one of the movable pressing blocks toward at least one of the regions generate a pressing force.

17. The semiconductor package workpress module having pressing blocks according to claim 16, wherein the at least one internal chamber includes a plurality of internal chambers; the at least one elastic member includes a plurality of elastic members; and
the elastic members are respectively accommodated in the internal chambers and respectively correspond to the open slots.

18. The semiconductor package workpress module having pressing blocks according to claim 16, wherein the at least one elastic member is at least one selected from the group consisting of a spring, a rubber and a shape-memory alloy.

19. The semiconductor package workpress module having pressing blocks according to claim 16, wherein the at least one elastic member includes a sack, and the sack is filled with a high-pressure fluid.

20. The semiconductor package workpress module having pressing blocks according to claim 19, wherein a material of the sack is at least one selected from the group consisting of nylon, polyurethane, polyvinyl chloride, thermoplastic polyurethane, rubber, polyethylene, and silicone.
